(19) United States
(12) Patent Application Publication
(10) Pub. No.: US 2010/0169270 A1
(43) Pub. Date: Jul. 1, 2010

(54) DYNAMIC PERSISTENT ACTIVITIES IN ACTIVITY-CENTRIC COMPUTING

(75) Inventors: Charles R. Hill, Belmont, MA (US); Martin T. Moore, New York, NY (US); Scott H. Prager, Strathem, NH (US)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/347,602

(22) Filed: Dec. 31, 2008

(51) Int. Cl. G06F 17/30

(52) U.S. Cl. 707/608; 707/E17.108; 707/E17.032

(57) ABSTRACT

Embodiments of the present invention provide a method, system and computer program product for managing dynamic and persistent activity objects in an activity in an activity-centric computing (ACC) system. In an embodiment of the invention, the system can include an ACC system executing in a host server coupled both to a data store of activities and external sources of dynamic content over a computer communications network. The ACC system can be configured to manage an activity structure for an activity in the data store of activities in that the activity structure can include a hierarchical arrangement of activity objects representing underlying static content. The system also can include a dynamic activity module coupled to the ACC system. The module can include program code enabled to insert into the activity structure a dynamic activity object subscribing to one of the external sources of dynamic content to render corresponding dynamic content received from the one of the external sources.

### BACKGROUND OF THE INVENTION

1. Field of the Invention

The present invention relates to the field of activity-centric computing and more particularly to activity management in an activity-centric computing system.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Personal information managers, project management systems and workflow management systems represent three such computing applications which attempt to manage a process leading to an objective, leveraging of the participation of many individuals in the process. Considering first the personal information manager (PIM), in a PIM, a single end user can establish a calendar of events and a to-do list of tasks which are to be performed by the end user. Project management systems provide means for an individual or a group to define and track project stages with strictly-specified interdependencies. Workflow management systems differ substantially from PIMs and project management systems. In a workflow management system, different computing processes can be linked together by an electronic specification. Moreover, in a workflow management system, it is not important whether all of the computing processes are managed by a single entity and different parts of the computing processes can be distributed about a network of diverse computing resources.

Notwithstanding the foregoing, individualized PIMs, project management systems, and workflow management systems do not account for the actual nature of a coordinated set of collaborative tasks conducted by people, such as an activity. An activity, unlike a typical project or workflow, is focused on enabling the achievement of a work-based, real-world goal across people and tools. In particular, activities organize and integrate resources, tools, and participants around the computational concept of a work activity. By comparison, individualized PIMs, project management systems and workflow management systems organize data according to the tool creating the data, such as a task list, calendar, messaging client, etc.

Generally, an activity includes a set of related, shared objects representing a task or a project. The set of related objects are structured as a hierarchical thread or other user-defined grouping, referred to as an “activity outline” or “activity structure” representing the context of the task at hand. Activity templates extend the notion of the activity structure by capturing ad hoc business processes and best practices for later reuse and modification for specialization or personalization. An activity-centric computing (ACC) system is designed to help collaborators organize and coordinate collaborative work through the activity paradigm. Existing ACC systems permit activities to be manually or automatically created, but also permit the content of each activity to be defined by the participants in those activities. Commercially published ACC systems provide a centralized, Web based service including extensions for desktop applications. The Web based service, for each participant, provides a Web based user interface to a listing of activities associated with the participant.

Of import, the content of an activity in an ACC system relates statically defined objects pertaining to a task or project. For example, an activity can include a hierarchical arrangement of activity objects, such as to-dos, calendar entries, documents, Web links, chat transcripts, messages and the like. Adding an object to an activity is a matter of selecting the object and specifying an activity to which the object is to be associated. Yet, managing a task or project implicates more than mere static objects arranged into an activity. In many circumstances, activity objects become contextually relevant for only a period of time and only for one or more participants in an activity. This fails to capture or enable a common way in which people manage work. To manage the dynamic nature of the contextual relevance of an activity object, then, requires participants to constantly police the hierarchical structure of the activity structure to remove outmoded objects and to add in newly en vogue objects of contextual relevance.

### BRIEF SUMMARY OF THE INVENTION

Embodiments of the present invention address deficiencies of the art in respect to ACC systems and provide a novel and non-obvious method, system and computer program product for managing dynamic and persistent activity objects in an activity in an ACC system. In an embodiment of the invention, ACC data processing system can be provided. The ACC data processing system can include an ACC system executing in a host server coupled both to a data store of activities and external sources of dynamic content over a computer communications network. The ACC system can be configured to manage an activity structure for an activity in the data store of activities in that the activity structure can include a hierarchical arrangement of activity objects representing underlying static content.

The system also can include a dynamic activity module coupled to the ACC system. The dynamic activity module can include program code enabled to insert into the activity structure a dynamic activity object subscribing to one or more of the external sources of dynamic content to render corresponding dynamic content received from these external sources. In one aspect of the embodiment, the dynamic activity object can specify a temporal relevance for the corresponding dynamic content such that the program code of the dynamic activity module can be further enabled to remove the corresponding dynamic content from the activity structure when the corresponding dynamic content is not temporally relevant according to the temporal relevance specified by the dynamic activity object and to automatically add new relevant dynamic content to the activity structure when it is temporally relevant. In another aspect of the embodiment, the dynamic activity object can specify a frequency of updating for the corresponding dynamic content such that the program code of the dynamic activity module can be further enabled to update the corresponding dynamic content in the activity structure according to the frequency of updating specified by the dynamic activity object.

In another embodiment of the invention, a method for managing dynamic and persistent activity objects in an activity in an ACC system can be provided. The method can include inserting activity objects in an activity structure for an activity managed by an ACC system executing in a host server. Each of the activity objects can reference underlying static content. The method also can include creating a dynamic activity object subscribing to a source of dynamic content external to the ACC system and inserting the dynamic activity object into the activity structure at a specified position in the activity structure. Finally, the method can include displaying dynamic content provided by the source of dynamic content at the specified position.

In one aspect of the embodiment, the method further can include updating the dynamic content displayed at the specified position according to a specified frequency of updating for the dynamic activity object. In another aspect of the embodiment, the method can include removing the dynamic content from display in the activity structure when the dynamic content is determined not to be temporally relevant according to a specified temporal relevance of the dynamic activity object. In even yet another aspect of the embodiment, creating a dynamic activity object subscribing to a source of dynamic content external to the ACC system, can include creating a dynamic activity object with a markup language reference to a Really Simple Syndication (RSS) feed, atom feed or other feed subscribing to a source of dynamic content external to the ACC system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for managing dynamic and persistent activity objects in an activity in an ACC system;

FIG. 2 is a schematic illustration of an ACC system configured for managing dynamic and persistent activity objects in an activity; and,

FIG. 3A and 3B, taken together, are a flow chart illustrating a process for managing dynamic and persistent activity objects in an activity in an ACC system.

### DETAILED DESCRIPTION OF THE INVENTION

Embodiments of the present invention provide a method, system and computer program product for managing dynamic and persistent activity objects in an activity in an ACC system. In accordance with an embodiment of the present invention, an activity can be established within an ACC system including multiple different static activity objects arranged hierarchically or by grouping in furtherance of a task or project. Additionally, a reference to a source of a dynamically changing object can be added to the activity. Optionally, the reference can include a temporal relevance indicating during which time period the dynamically changing object is to remain as part of the activity. As yet another option, the reference can specify a frequency in which the dynamically changing object is updated within the activity. In this way, contextually and temporally relevant objects can be added to an activity dynamically by reference to a source of the contextually relevant objects instead of to a static instance of an object.

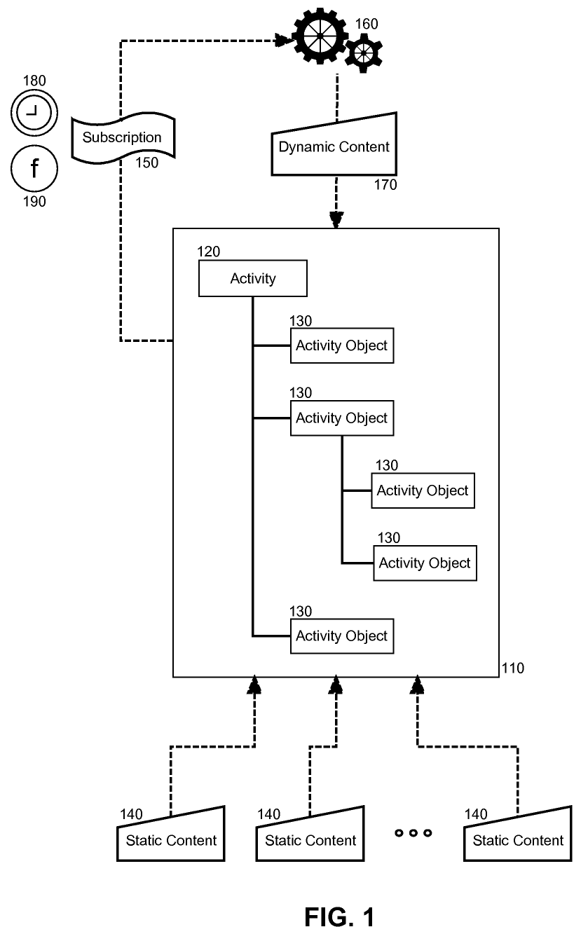

In further illustration, FIG. 1 pictorially shows a process for managing dynamic and persistent activity objects in an activity in an ACC system. As shown in FIG. 1, an activity structure 110 can be created for an activity 120 with multiple different activity objects 130 arranged hierarchically. The activity objects 130 can refer to static content 140, such as an established to-do, calendar entry, milestone, document, Web link, chat transcript, message and the like. However, at least one of the activity objects 130 can refer to a subscription 150 to a content source 160 of dynamic content 170. For instance, the subscription 150 can define in markup an RSS feed to the dynamic content 170 at the content source 160. Further, the subscription 150 can specify a temporal relevance 180 of the dynamic content 170, a frequency in which the dynamic content 170 is to be updated in the activity structure 110, or both.

The activity object 130 referring to a subscription 150 can incorporate the corresponding dynamic content 170 in the activity structure 11 0. However, the temporal relevance 180 for the subscription 150 can be compared a time or date stamp for the dynamic content 170 to determine whether the dynamic content 170 has maintained its temporal relevance. For example, to the extent the dynamic content 170 is an e-mail message, the date of the e-mail message can be compared to the temporal relevance 180 of the subscription 150 to determine whether or not the e-mail message remains temporally relevant to the activity 120. Further, the specification of frequency 190 can be used to determine how often to update the dynamic content 170 in the activity structure 110 for the subscription 150.

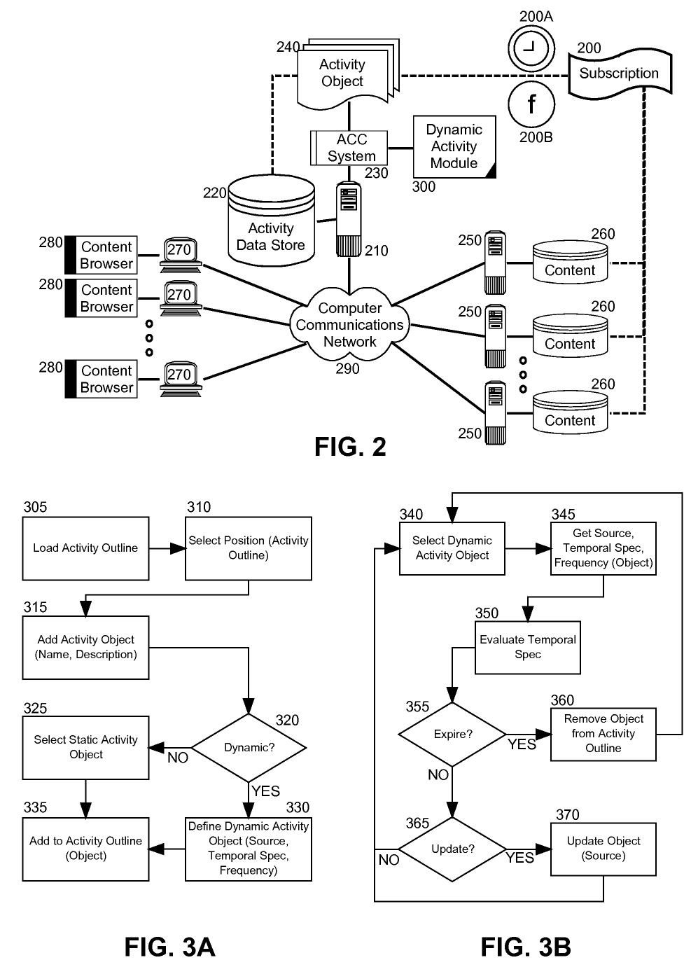

The process described in connection with FIG. 1 can be implemented within an ACC system. In yet further illustration, FIG. 2 schematically shows an ACC data processing system configured for managing dynamic and persistent activity objects in an activity. The system can include a host server 210 coupled to a data store of activities 220 and supporting the execution of an ACC system 230. The host server 210 can be configured for communicative coupling to different clients 270 over computer communications network 290. Each of the clients 270 can include a content browser 280 configured to render a user interface to the ACC system 230 to view different activity structures of different activity objects 240 for respective activities disposed in the data store of activities 220.

Notably, a dynamic activity module 300 can be coupled to the ACC system 230. The dynamic activity module 300 can include program code enabled to access different servers 250 serving correspondingly different content 260 from over computer communications network 290. In this regard, the content 260 can include e-mail messages managed within an e-mail server, to-dos managed within a to-do list, calendar entries in a calendaring and scheduling system, etc. Further, the program code of the dynamic activity module 300 can be enabled to insert a reference to a subscription 200 to the dynamic content 260 in the activity objects 240 of an activity in the data store of activities 220. Yet further, the program code of the dynamic activity module 300 can be enabled to update the dynamic content 260 with a frequency 200B specified by the subscription 200, and to remove the dynamic content 260 from the activity when the dynamic content 260 no longer meets a specified temporal relevance 200A in the subscription 200 to the dynamic content 260.

In even yet further illustration of the operation of the dynamic activity module 300, FIGS. 3A and 3B, taken together, are a flow chart illustrating a process for managing dynamic and persistent activity objects in an activity in an ACC system. With respect to FIG. 3A, a process is shown for adding a subscription to dynamic content in an activity structure of an activity. Beginning in block 305, an activity structure can be loaded and a position within the activity structure can be selected in block 3 10. In block 315, an activity object can be created for insertion into the activity structure at the selected position and a name and description can be applied to the activity object.

In decision block 320, it can be determined whether the activity object refers to static content, or dynamic content. If in decision block 320, it is determined that the activity object refers to static content, then in block 325 the static object can be selected and added to the activity structure in block 335 at the selected position. Otherwise, in block 330, a dynamic activity object can be defined as a subscription to dynamic content at a specified content source along with a specification of temporal relevance and a specification of a frequency in which to update the dynamic content from the specified content source. In this regard, the subscription can include a markup language specification of a RSS feed to the specified content source. Thereafter, in block 335 the dynamic activity object can be added to the activity structure at the specified position.

Turning now to FIG. 3B, once a dynamic activity object has been inserted into the activity structure, dynamic content from a specified source of the dynamic content can be updated in the activity structure at a frequency specified by the dynamic activity object when the dynamic activity object is determined to be temporally relevant according to the specified temporal relevance. Further, the dynamic content can be removed from the activity structure when the dynamic activity object is determined to no longer be temporally relevant according to the specified temporal relevance.

More particularly, in block 340 a dynamic activity object in the activity structure can be selected for processing and in block 345, a source of dynamic content for the dynamic activity object can be determined along with a specification of temporal relevance and a frequency. In block 350, the specification of temporal relevance can be compared to a time or date stamp for dynamic content provided by the source of the dynamic content. In decision block 355, if the dynamic content is no longer temporally relevant, in block 360 the dynamic content can be removed from the activity structure. Otherwise, in decision block 365 it can be determined whether or not the specification of frequency for the dynamic activity object merits an update of corresponding dynamic content. If so, in block 370 the dynamic activity object can be updated with an updated form of corresponding dynamic content (which can include both modifications to dynamic activity objects in the activity as well as the addition of new activity objects to the activity structure). Thereafter, the process can return to block 340.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An activity-centric computing (ACC) data processing system comprising:
an ACC system executing in a host server coupled both to a data store of activities and a plurality of external sources of dynamic content over a computer communications network, the ACC system being configured to manage an activity structure for an activity in the data store of activities, the activity structure comprising a hierarchical arrangement of activity objects representing underlying static content; and,
a dynamic activity module coupled to the ACC system, the dynamic activity module comprising program code enabled to insert into the activity structure a dynamic activity object subscribing to one of the external sources of dynamic content to render corresponding dynamic content received from the one of the external sources.

2. The system of claim 1, wherein the dynamic activity object specifies a temporal relevance for the corresponding dynamic content and wherein the program code of the dynamic activity module is further enabled to remove the corresponding dynamic content from the activity structure when the corresponding dynamic content is not temporally relevant according to the temporal relevance specified by the dynamic activity object.

3. The system of claim 1, wherein the dynamic activity object specifies a frequency of updating for the corresponding dynamic content and wherein the program code of the dynamic activity module is further enabled to update the corresponding dynamic content in the activity structure according to the frequency of updating specified by the dynamic activity object.

4. The system of claim 1, wherein the dynamic activity object specifies a frequency of updating for the corresponding dynamic content and wherein the program code of the dynamic activity module is further enabled to insert the corresponding new dynamic content in the activity structure according to the frequency of updating specified by the dynamic activity object.

5. The system of claim 1, wherein the dynamic activity object comprises feed selected from the group consisting of a really simple syndication (RSS) feed and an atom feed to the one of the external sources of dynamic content.

6. The system of claim 1, wherein the dynamic content is an e-mail message and the one of the external sources of dynamic content comprises an e-mail server.

7. The system of claim 1, wherein the dynamic content is a to-do and the one of the external sources of dynamic content comprises a to-do list.

8. The system of claim 1, wherein the dynamic content is a calendar entry and the one of the external sources of dynamic content comprises a calendar and scheduling (C&S) system.

9. A method for managing dynamic and persistent activity objects in an activity in an activity-centric computing (ACC) system, the method comprising:
inserting a plurality of activity objects in an activity structure for an activity managed by an ACC system executing in a host server, each of the activity objects referencing underlying static content;
creating a dynamic activity object subscribing to a source of dynamic content external to the ACC system;
inserting the dynamic activity object into the activity structure at a specified position in the activity structure; and,
displaying dynamic content provided by the source of dynamic content at the specified position.

10. The method of claim 9, further comprising updating the dynamic content displayed at the specified position according to a specified frequency of updating for the dynamic activity object.

11. The method of claim 9, further comprising inserting the dynamic content displayed at the specified position according to a specified frequency of updating for the dynamic activity object.

12. The method of claim 9, further comprising removing the dynamic content from display in the activity structure when the dynamic content is determined not to be temporally relevant according to a specified temporal relevance of the dynamic activity object.

13. The method of claim 9, wherein creating a dynamic activity object subscribing to a source of dynamic content external to the ACC system, comprises creating a dynamic activity object with a markup language reference to a feed selected from the group consisting of a Really Simple Syndication (RSS) feed and an atom feed subscribing to a source of dynamic content external to the ACC system.

14. A computer program product comprising a computer usable medium embodying computer usable program code for managing dynamic and persistent activity objects in an activity in an activity-centric computing (ACC) system, the computer program product comprising:
computer usable program code for inserting a plurality of activity objects in an activity structure for an activity managed by an ACC system executing in a host server, each of the activity objects referencing underlying static content;
computer usable program code for creating a dynamic activity object subscribing to a source of dynamic content external to the ACC system;
computer usable program code for inserting the dynamic activity object into the activity structure at a specified position in the activity structure; and,
computer usable program code for displaying dynamic content provided by the source of dynamic content at the specified position.

15. The computer program product of claim 14, further comprising computer usable program code for updating the dynamic content displayed at the specified position according to a specified frequency of updating for the dynamic activity object.

16. The computer program product of claim 14, further comprising computer usable program code for inserting the dynamic content displayed at the specified position according to a specified frequency of updating for the dynamic activity object.

17. The computer program product of claim 14, further comprising computer usable program code for removing the dynamic content from display in the activity structure when the dynamic content is determined not to be temporally relevant according to a specified temporal relevance of the dynamic activity object.

18. The computer program product of claim 14, wherein the computer usable program code for creating a dynamic activity object subscribing to a source of dynamic content external to the ACC system, comprises computer usable program code for creating a dynamic activity object with a markup language reference to a feed selected from the group consisting of a Really Simple Syndication (RSS) feed and an atom feed subscribing to a source of dynamic content external to the ACC system.
